(19) United States
(12) Patent Application Publication
(10) Pub. No.: US 2006/0219074 A1
(43) Pub. Date: Oct. 5, 2006

(54) Work table

(76) Inventor: Charlie Zhang, Oak Brook, IL (US)

Correspondence Address: Kevin D. Erickson;Pauley Petersen & Erickson, Suite 365, 2800 West Higgins Road, Hoffman Estates, IL, 60195, US

(21) Appl. No.: 11/098,183

(22) Filed: Apr. 4, 2005

(51) Int. Cl. B27B 27/06

(52) U.S. Cl. 83/471.3

(57) ABSTRACT

A work table including a base forming a slot on a top surface of the base. A rotatable cutting blade is mounted to the base, with at least a portion of the cutting blade extending through the slot. A motor is housed within the base and in operational communication with the cutting blade effective to rotate the cutting blade. A guide element is positioned with respect to the top surface and a support surface is movable in a cutting direction along a length of the guide element and with respect to the cutting blade. The support surface has a work area for supporting a work piece and forms a passage aligned with the cutting blade.

### BACKGROUND OF THE INVENTION

1. Field of the Invention

This invention relates generally to a work table and, more particularly, to a work table including a support surface that is movable in a cutting direction with respect to a cutting blade mounted to the work table.

2. Description of Related Art

Conventional work tables typically include a stationary, rotatable cutting blade mounted with respect to a fixed support surface of the work table. A work piece is moved along a length of the support surface towards the cutting blade in order to cut the work piece, as desired. Several problems and/or shortcomings are associated with these conventional work tables. For example, it is difficult to hold or secure the work piece as the work piece is moved towards the cutting blade. Thus, as the work piece is moved towards the cutting blade, the work piece may shift or move away from the desired cutting line, resulting in an inaccurate cut.

### SUMMARY OF THE INVENTION

It is one object of this invention to provide an improved work table having a support surface with a work area for supporting a work piece, such as a wood, metal, stone or tile work piece.

It is another object of this invention to provide a work table having a support surface that is movable in a cutting direction with respect to a cutting blade for accurately cutting the work piece.

It is yet another object of this invention to provide a work table having a support surface that is slidably movable in the cutting direction along a length of a guide element extending along a base of the work table for accurately cutting the work piece.

The above and other objects of the invention can be attained through a work table including a base forming a slot on a top surface of the base. A rotatable cutting blade is mounted to and/or disposed within the base, with at least a portion of the cutting blade extending through the slot. Preferably, a height of the cutting blade that extends through the slot is adjustable, as well as a cutting angle of the cutting blade with respect to the top surface of the base and/or a work area defined by a support surface. The cutting blade is operatively coupled to a motor housed within the base. The motor is in operational communication with the rotatable cutting blade to effectively rotate the cutting blade.

The work table preferably includes a guide element positioned with respect to the top surface. The support surface includes or defines a work area that supports a work piece. The support surface also forms a passage aligned with the cutting blade along a cutting line. The support surface is movable in a cutting direction along a length of the guide element and with respect to the cutting blade. The guide element preferably includes at least one guide bar mounted with respect to the top surface and a support bar positioned with respect to each guide bar. The support bar is positionable within a cooperating channel formed in the support surface. The support bar is slidably movable with respect to the guide bar and the support surface is slidably movable with respect to the support bar.

In one preferred embodiment of this invention, the work table includes a first guide bar that is positioned with respect to a first side of the cutting blade and extends between a first end portion of the base and a second end portion of the base. The first guide bar is parallel with the cutting blade. A first support bar is positionable about the first guide bar, for example in a telescoping relationship, and slidably movable along a length of the first guide bar with respect to the cutting blade. A second guide bar is positioned with respect to a second side of the cutting blade and extends between a first end portion of the base and a second end portion of the base. The second guide bar is also parallel with the cutting blade. A second support bar is positionable about the first guide bar, for example in a telescoping relationship, and slidably movable along a length of the second guide bar with respect to the cutting blade. The support surface forms a first channel positionable about the first support bar, for example in a telescoping relationship, and a second channel positionable about the second support bar, for example in a telescoping relationship. The support surface is slidably movable along a length of each of the first support bar and the second support bar with respect to the cutting blade.

The work table may also include a track formed at a first side portion and/or a second side portion of the base. A corresponding edge portion of the support surface is slidably mounted within the track to guide the support surface in the cutting direction with respect to the cutting blade. Preferably, at least one roller element, such as a roller, a wheel or a bearing, is rotatably or slidably mounted to each edge portion and positionable within the corresponding track. The work table may also include a stop bar that extends along at least a portion of a width of the support surface. The stop bar is preferably positioned perpendicular to the cutting direction and provides support for the work piece as the work piece is cut. A water tray is preferably positioned within the base and connected with respect to the support surface. The water tray forms or defines a reservoir that contains a cooling fluid, such as water, to cool the cutting blade as the cutting blade rotates through the base during operation of the work table.

Other objects and advantages of this invention are apparent to those skilled in the art, in view of the following detailed description taken in conjunction with the appended claims and drawings.

### BRIEF DESCRIPTION OF THE DRAWINGS

FIG. 1 is a perspective view of a work table including a support surface movably mounted to a base of the work table, with the support surface in an extended or starting position with respect to a cutting blade, according to one preferred embodiment of this invention;

FIG. 2 is a perspective view of a work table including a support surface movably mounted to a base of the work table, with the support surface in an intermediate or cutting position with respect to a cutting blade, according to one preferred embodiment of this invention;

FIG. 3 is a top view of a portion of a work table showing a support surface that is movably mountable to a base of the work table, with the support surface movable along a length of two support bars, according to one preferred embodiment of this invention;

FIG. 4 is a side view of the portion of the work table shown in FIG. 3; and

FIG. 5 is a magnified side view of the portion of the work table shown in FIG. 4.

### DETAILED DESCRIPTION OF THE INVENTION

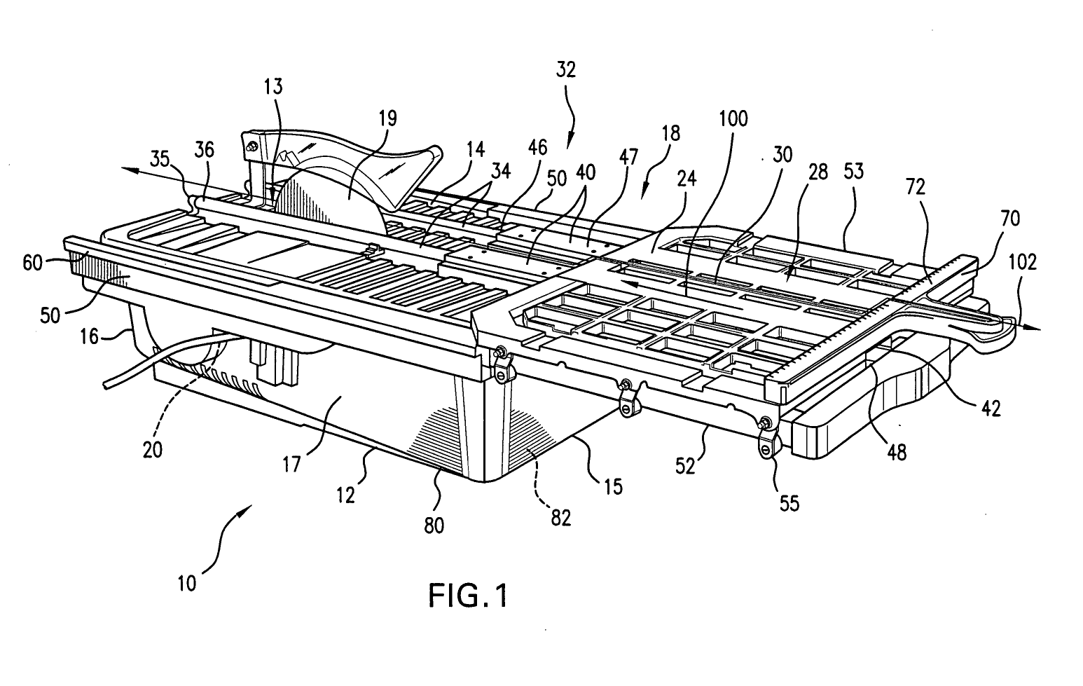

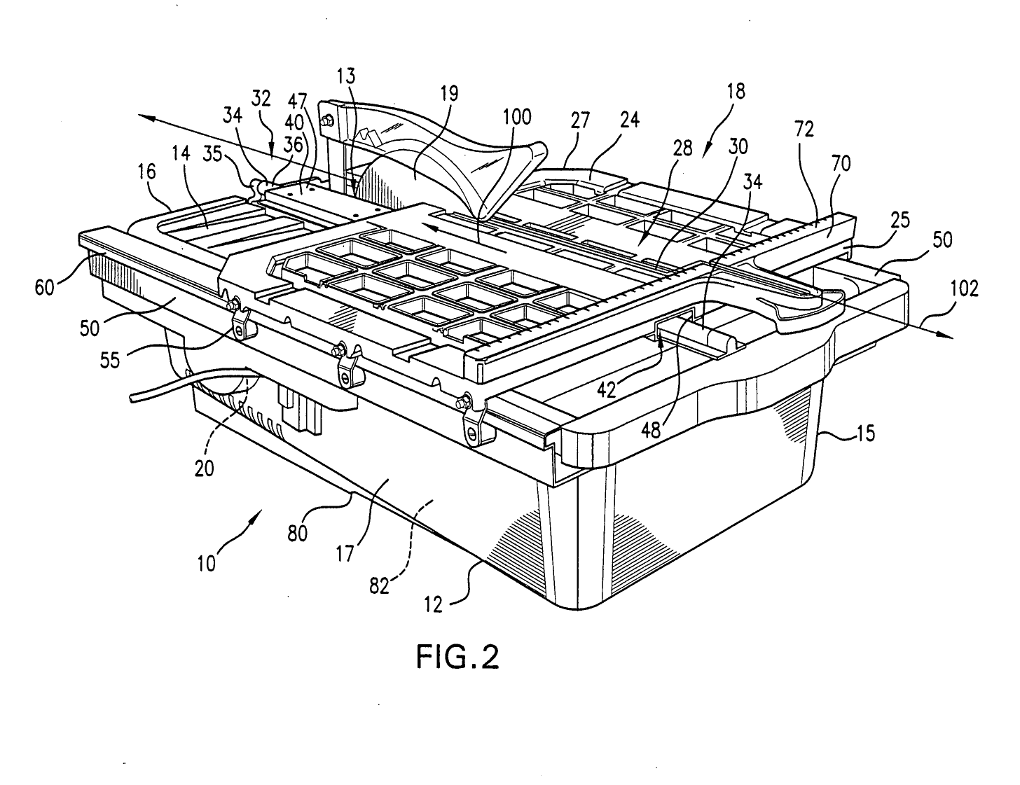

Referring to FIGS. 1 and 2, the present invention provides a work table 10 including a base 12. Preferably, base 12 is made or formed of a suitable lightweight yet durable material, such as a fabricated metal or alloy material or a molded plastic material. Other suitable materials known to those skilled in the art can be used to make or form base 12. Preferably, base 12 has suitable dimensions and weight to allow work table 10 to be portable. Base 12 includes or forms a slot 13 on a top surface 14 of base 12. Base 12 has a first or front end portion 15 and a longitudinally opposing second or back end portion 16, and a first side portion 17 and a laterally opposing second side portion 18.

A rotatable cutting blade 19 is mounted to and/or disposed within base 12. Cutting blade 19 may be any suitable cutting blade known to those skilled in the art and chosen according to the work piece material to be cut using work table 10. Further, cutting blade 19 may have any suitable diameter. As shown in FIGS. 1 and 2, at least a portion of cutting blade 19 extends through slot 13 and extends a desired distance from top surface 14 of base 12. In one preferred embodiment of this invention, a height or distance of cutting blade 19 extending through slot 13 is adjustable, as desired to cut into and/or through the work piece. For example, cutting blade 19 may be secured within a blade mount (not shown) disposed within base 12. The blade mount permits vertical adjustment of rotatable cutting blade 19 relative to top surface 14. Preferably, a cutting angle of cutting blade 19 with respect to top surface 14 and a work area, discussed below, is also adjustable to cut the work piece at a desired cutting angle.

A motor 20 is housed within base 12 and in operational communication with rotatable cutting blade 19. Motor 20 may be any suitable motor that supplies sufficient power effective to rotate cutting blade 19 at a desired speed and/or with a desired torque.

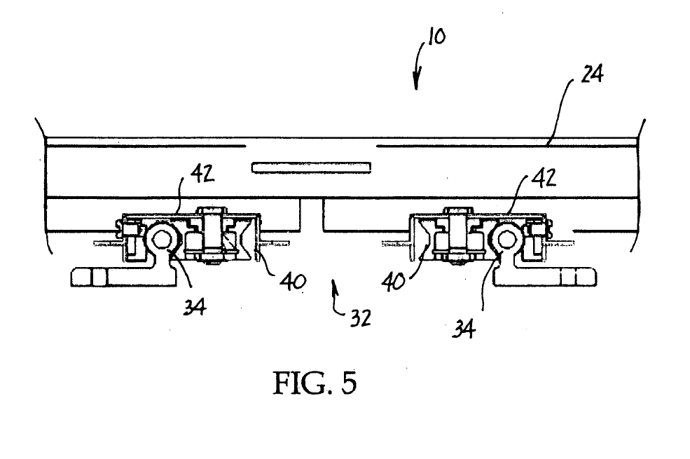

Referring to FIGS. 1-5, work table 10 includes a support surface 24 having a first or front end portion 25 and a second or back end portion 27 and having or defining a work area 28. Work area 28 provides support for a work piece, such as a wood, metal, stone or tile work piece. Support surface 24 includes or forms a passage 30 along/and or through work area 28 in a longitudinal or cutting direction, as indicated by arrow 100 in FIG. 1, and aligned with cutting blade 19 along a cutting line 102. Preferably, but not necessarily, passage 30 in the cutting direction is generally perpendicular to first end portion 25 and second end portion 27 of support surface 24. Support surface 24 is movable in the cutting direction with respect to base 12 and/or cutting blade 19 to move the work piece towards cutting blade 19 and pass the work piece through work area 28 to cut into and/or through the work piece using cutting blade 19. As support surface 24 is moved with respect to cutting blade 19, cutting blade 19 may extend into and be positioned within passage 30 to cut through the work piece. In one preferred embodiment of this invention, support surface 24 includes a lattice configuration, as shown in FIGS. 1-3. Support surface 24 is preferably made of a suitable lightweight and strong metal, alloy or composite material, such as an aluminum material.

Preferably, work table 10 includes a guide element 32 positioned with respect to top surface 14. Support surface 24 is movable in the cutting direction along a length of guide element 32 and with respect to cutting blade 19. In one preferred embodiment of this invention, guide element 32 includes at least one guide bar 34 mounted with respect to top surface 14. Support surface 24 is mountable with respect to each guide bar 34 and slidably movable in the cutting direction along a length of guide bars 34. As shown in FIGS. 1 and 2, guide bar 34 is preferably attached or connected at each of front end portion 15 of base 12 and back end portion 16 of base 12 using a suitable connector, such as a strap or bracket 35. Guide bar 34 is parallel to cutting blade 19. Preferably, guide bar 34 is generally cylindrical. Alternatively, guide bar 34 may have a general rectangular cross-sectional shape and include a groove for receiving a portion of a support bar 40, discussed below. Guide bar 34 may have any suitable dimension and/or cross-sectional shape known to those skilled in the art.

Support bar 40 is positioned with respect to each guide bar 34 and positionable within a corresponding or cooperating channel 42 formed in support surface 24. In one preferred embodiment of this invention, support bar 40 is slidably movable with respect to guide bar 34 and support surface 24 is slidably movable with respect to support bar 40. Preferably, an outer periphery 36 of guide bar 34 corresponds to a surface of support bar 40 forming a bore 46 within which guide bar 34 is positionable. Additionally, an outer periphery 47 of support bar 40 preferably corresponds to an inner surface 48 of channel 42 within which support bar 40 is positionable. For example, in one preferred embodiment of this invention, support bar 40 is positionable in a telescoping relationship about corresponding guide bar 34 and is slidably movable along a length of guide bar 34 with respect to cutting blade 19. Further, support bar 40 is positionable within channel 42 such that channel 42 is positioned in a telescoping relationship about support bar 40. Support surface 24 is slidably movable along a length of support bar 40 with respect to cutting blade 19.

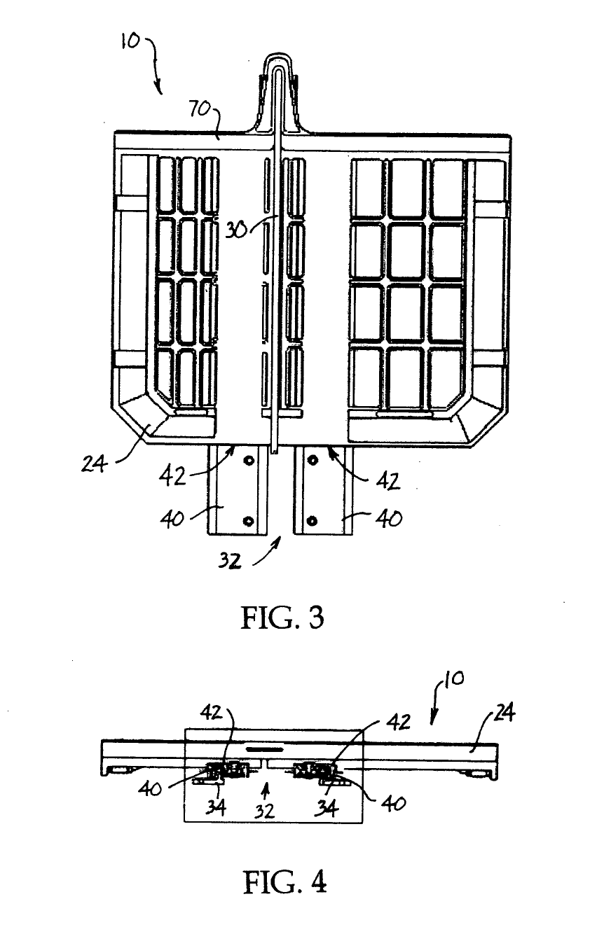

The term “telescoping relationship” refers to the cooperation of two members or elements, such as a guide bar 34 and a corresponding support bar 40 and/or a support bar 40 and a corresponding channel 42 formed in support surface 24, wherein a first member or element is positionable within a second member or element and slidably movable within the second member or element between a retracted position and an extended position. FIG. 1 shows support bar 40 positioned about guide bar 34 and support bar 40 positioned within channel 42 in a partially retracted or intermediate position. FIG. 2 shows support bar 40 positioned about guide bar 34 and support bar 40 positioned within channel 42 in an extended position. FIG. 3 shows support bar 40 positioned within channel 42 in a partially retracted position.

In one preferred embodiment of this invention, as shown in FIGS. 1 and 2, a first guide bar 34 is positioned on a first side of work area 28 with respect to a first side of cutting blade 19. Similarly, a second guide bar 34 is positioned on an opposing second side of work area 28 with respect to a second side of cutting blade 19. First guide bar 34 is parallel with second guide bar 34. A first support bar 40 is positioned with respect to corresponding first guide bar 34 and positionable within a corresponding first channel 42 formed in support surface 24. First support bar 40 is slidably movable with respect to a length of first guide bar 34 and support surface 24 is slidably movable with respect to a length of first support bar 40. Similarly, a second support bar 40 is positioned with respect to corresponding second guide bar 34 and positionable within a corresponding second channel 42 formed in support surface 24. Second support bar 40 is slidably movable with respect to a length of second guide bar 34 and support surface 24 is slidably movable with respect to a length of second support bar 40.

In one preferred embodiment of this invention, a track 50 is formed in or connected to first side portion 17 and/or on second side portion 18 of base 12. A first edge portion 52 of support surface 24 is slidably mounted with respect to or within track 50 formed in or connected to first side portion 17 and a second edge portion 53 of support surface 24 is slidably mounted within track 50 formed in or connected to second edge portion 53 to guide support surface 24 in the cutting direction with respect to cutting blade 19. Preferably, at least one roller element 55, such as a roller, a wheel or a bearing, is rotatably or slidably mounted to edge portion 52 and/or edge portion 53 and positionable within track 50. In one preferred embodiment of this invention, track 50 includes or forms a lip or ledge 60 along a length of track 50 which contacts and/or supports roller element 55 as support surface 24 is moved with respect to cutting blade 19.

As shown in FIGS. 1 and 2, support surface 24 may include a stop bar 70 that extends along at least a portion of a width of support surface 24. Stop bar 70 is preferably positioned perpendicular to the cutting direction and provides support for the work piece. In one preferred embodiment of this invention, stop bar 70 includes a measuring tape 72 to laterally align the work piece with respect to cutting blade 19, as desired.

Work table 10 may also include a water tray 80 connected with respect to top surface 14 of base 12, as shown in FIGS. 1 and 2. Water tray 80 defines or forms a reservoir 82 for containing water or any suitable fluid for cooling cutting blade 19 as cutting blade 19 cuts through the work piece. Preferably, slot 13 is in fluid communication with reservoir 82 so that as cutting blade 19 rotates to cut through the work piece, at least a portion of cutting blade 19 extends into the water or cooling fluid contained within reservoir 82 to cool cutting blade 19.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A work table comprising:
a base forming a slot on a top surface of the base;
a rotatable cutting blade mounted to the base, at least a portion of the cutting blade extending through the slot;
a motor housed within the base and in operational communication with the cutting blade effective to rotate the cutting blade;
a guide element positioned with respect to the top surface; and
a support surface having a work area for supporting a work piece and forming a passage aligned with the cutting blade, the support surface movable in a cutting direction along a length of the guide element and with respect to the cutting blade.

2. The work table of claim 1 wherein the guide element comprises at least one guide bar mounted with respect to the top surface.

3. The work table of claim 2 further comprising:
a support bar positioned with respect to each guide bar of the at least one guide bar and positionable within a channel formed in the support surface, wherein the support bar is slidably movable with respect to the guide bar and the support surface is slidably movable with respect to the support bar.

4. The work table of claim 1 wherein the guide element comprises a first guide bar positioned on a first side of the cutting blade and a second guide bar positioned on an opposing second side of the cutting blade, the second guide bar parallel with the first guide bar.

5. The work table of claim 4 further comprising:
a first support bar positioned with respect to the first guide bar and positionable within a first channel formed in the support surface, the first support bar slidably movable with respect to a length of the first guide bar and the support surface slidably movable with respect to a length of the first support bar; and
a second support bar positioned with respect to the second guide bar and positionable within a second channel formed in the support surface, the second support bar slidably movable with respect to a length of the second guide bar and the support surface slidably movable with respect to a length of the second support bar.

6. The work table of claim 1 further comprising:
a track formed at at least one side portion of the base, an edge portion of the support surface slidably mounted with respect to the track to guide the support surface in the cutting direction with respect to the cutting blade.

7. The work table of claim 6 further comprising:
at least one roller element rotatably mounted to the edge portion and positionable on a ledge of the track.

8. The work table of claim 1 further comprising:
a stop bar extending along at least a portion of a width of the support surface, the stop bar positioned perpendicular to the cutting direction.

9. The work table of claim 1 further comprising:
a water tray positioned within the base and connected with respect to the support surface, the water tray forming a reservoir.

10. The work table of claim 9 wherein the slot is in fluid communication with the reservoir.

11. A work table comprising:
a base forming a slot on a top surface of the base;
a rotatable cutting blade mounted to the base, at least a portion of the cutting blade extending through the slot;
a motor housed within the base and in operational communication with the cutting blade effective to rotate the cutting blade;
a first guide bar positioned with respect to a first side of the cutting blade and extending between a first end portion of the base and an opposing second end portion of the base, the first guide bar parallel with the cutting blade;
a first support bar positionable in a telescoping relationship about the first guide bar and slidably movable along a length of the first guide bar with respect to the cutting blade;
a second guide bar positioned with respect to a second side of the cutting blade and extending between the first end portion of the base and the second end portion of the base, the second guide bar parallel with the cutting blade;
a second support bar positionable in a telescoping relationship about the second guide bar and slidably movable along a length of the second guide bar with respect to the cutting blade; and
a support surface having a work area for supporting a work piece and forming a passage through the work area in a cutting direction, the support surface forming a first channel positionable in a telescoping relationship about the first support bar and a second channel positionable in a telescoping relationship about the second support bar, the support surface slidably movable along each of a length of the first support bar and a length of the second support bar with respect to the cutting blade.

12. The work table of claim 11 wherein each of the first guide bar and the second guide bar is generally cylindrical.

13. The work table of claim 11 wherein an outer periphery of the first guide bar corresponds to a surface of the first support bar forming a bore within which the first guide bar is positionable.

14. The work table of claim 11 wherein an outer periphery of the first support bar corresponds to an inner surface of the first channel within which the first support bar is positionable.

15. The work table of claim 11 wherein a height of the cutting blade extending through the slot is adjustable.

16. The work table of claim 11 wherein a cutting angle of the cutting blade with respect to the work area is adjustable.

17. A work table comprising:
a base forming a slot on a top surface of the base;
a rotatable cutting blade mounted to the base, at least a portion of the cutting blade extending through the slot;
a motor housed within the base and in operational communication with the cutting blade effective to rotate the cutting blade;
a first guide bar positioned with respect to a first side of the cutting blade and extending between a first end portion of the base and an opposing second end portion of the base;
a second guide bar positioned with respect to a second side of the cutting blade and extending between the first end portion of the base and the second end portion of the base, the first guide bar parallel with the second guide bar;
a support surface having a work area for supporting a work piece and forming a passage through the work area, the passage aligned with the cutting blade along a cutting line, the support surface mountable with respect to each of the first guide bar and the second guide bar and slidably movable in a cutting direction along a length of the first guide bar and a length of the second guide bar;
a first track formed at a first side portion of the base, a first edge portion of the support surface slidably mounted with respect to the first track to guide the support surface in the cutting direction with respect to the cutting blade; and
a second track formed at an opposing second side portion of the base, a second edge portion of the support surface slidably mounted with respect to the second track to guide the support surface in the cutting direction with respect to the cutting blade.

18. The work table of claim 17 further comprising:
a first support bar positionable with respect to the first guide bar and movable along the length of the first guide bar; and
a second support bar positionable with respect to the second guide bar and movable along the length of the second guide bar.

19. The work table of claim 18 further comprising:
a first channel formed in the support surface, the first support bar positionable within the first channel and the support surface movable with respect to the first support bar; and
a second channel formed in the support surface, the second support bar positionable within the second channel and the support surface movable with respect to the second support bar.
